(19) United States
(12) Patent Application Publication
(10) Pub. No.: US 2002/0038298 A1
(43) Pub. Date: Mar. 28, 2002

(54) Management system and managing method for information of individuals

(76) Inventors: Moriaki Kusakabe, Ushiku-shi (JP); Hajime Asama, Asaka-shi (JP); Daisuke Kurabayashi, Tokyo-to (JP); Isao Endo, Tokyo-to (JP); Toshikazu Ebisuzaki, Wako-shi (JP)

Correspondence Address: BIRCH STEWART KOLASCH & BIRCH, PO BOX 747, FALLS CHURCH, VA, 22040-0747, US

(21) Appl. No.: 09/960,983

(22) Filed: Sep. 25, 2001

(30) Foreign Application Priority Data
Sep. 25, 2000 (JP) 2000-290919

(51) Int. Cl. G06F 17/30; G06K 5/00

(52) U.S. Cl. 707/1; 235/380; 705/3

(57) ABSTRACT

An individual information management system to manage individual data comprises a data carrier which is attached to said individual, and which stores data relating to said individual, and

an external device to read out data stored in said data carrier and write in new data in said data carrier by non-contact manner. For a plurality of individuals, an individual information management system comprises: a first data carrier which is attached to said individual, and which stores intrinsic data relating to said individual, a plurality of second data carriers which are assigned to groups which are obtained by dividing said individuals, and which store intrinsic data of individuals belonging to said groups, and an external device to read out intrinsic data from said first data carrier by non-contact manner and read out intrinsic data from said second data carriers by non-contact manner.

### BACKGROUND OF THE INVENTION

The present invention relates to a management system and a managing method for information of individuals and more particularly to an information management system and an information managing method to manage medical data of persons and the individual intrinsic data of animals for experiment, who and which are attached with the data carriers.

With the recent development of computer science and the related many kinds of interface instruments, and resulting development of the hardware environment to execute information operation, it has also become possible to qualitatively change the conventional concept of “information management”.

For example, concerning the research theme of how to store, exchange, process and manage the intrinsic data relating to different species of motionless or moving individuals by a fixedly equipped hardware, a new technical solution which is essentially different from the conventional concept has become possible. Therefore, it is necessary to re-recognize those essential themes that use the conventional information management methods.

One example will be described as follows. Conventionally, in medical facilities, medical records of persons have been recorded and stored in paper form or other electronic media. However, these medical records are dispersed in different medical facilities and are recorded/managed separately. A realistic technical means which can manage individual medical history or medical treatment records in a centralized manner whenever and wherever these data can be accessed, has not been developed yet.

Supposing that those medical records could be managed by a server located somewhere using the centralized managing method, the read-out/write-in of necessary data would not be possible except for

the case in which a user can access to the server. This means that utilizing data is limited to locations where accessing terminals are installed. Therefore, utilization of data will be impossible if connection via internet is failed or the server downs. Furthermore, if the server is out of order, all data would be lost, and when connecting the server from terminals through internet, defending means for protecting data from data changing or destroying by so-called ‘crackers’ and protecting means for protecting privacy. In other words, the centralized ‘network oriented’ management system contains many essential problems, and it is highly desirable to establish a so-called instance oriented system in which the information processing, managing, measuring, and controlling functions are given to a specified hardware which is independent from the network.

On the other hand, in research facilities and medicine makers which research medical science, biochemistry, and brain science, it is necessary to raise and manage many species of animals for experiment, such as mouse. This kind of raising work is very dull and troublesome, and its working environment is not sufficiently good for researchers. Accordingly, mechanization of such kind of raising work is strongly desired.

In some experiments, hereditary information of animals for experiment is very important. Such hereditary information of every animal is carefully handled by the researchers, however, it is not easy to completely prevent misidentifying and putting those animals back into wrong cages even though the researchers pay maximum attention. Moreover, when an accident occurs, there may happen troubles in which animals escape out from cages and multiple individuals of animals each having different hereditary information are mixed together. In such accident, correspondence between the hereditary information and the animals would be lost and as a result the experimental data accumulated for a long time would disappear.

### SUMMARY OF THE INVENTION

It is an object of the present invention to provide a novel management system and managing method for information of individuals in which various kinds of data relating to every species of individuals, such as human beings and animals, can be collected via data carriers attached to the individuals, which can obtain secure correspondence between data and individuals and can be easily obtained and the above data can be commonly among a plurality of fixed hardware.

According to one aspect of the present invention, there is provided an individual information management system to manage individual data comprising: a data carrier which is attached to said individual, and which stores data relating to said individual, and an external device to read out data stored in said data carrier and write in new data in said data carrier by non-contact manner.

According to another aspect of the present invention, there is provided an individual information management system to manage data of a plurality of individuals comprising: a plurality of data carriers which are assigned to groups which is obtained by dividing said individuals, and which store data belonging to said groups, and an external device to read out data from said data carriers and write in new data in said data carriers by non-contact manner.

Here, the term ‘attached’ includes not only the case where the individuals carry the data carrier by itself but also the case where the data carrier is fixed or set in the individual by others.

According to further aspect of the present invention, there is provided an individual information managing method comprising:

attaching a data carrier to an individual, said data carrier having storing function to store data relating to said individual, data input/output function to write new data in said data carrier from outside in non-contact manner and to read out stored data from said data carrier from outside in non-contact manner, said data carrier further having phisycal input/output function,

storing information relating to said individual,

whereby correspondence between said individual and said data relating to said individual being enhanced by carrying said data carrier.

According to still further aspect of the present invention, there is provided an individual information managing method for managing a plurality of individuals comprising:

attaching a plurality of first data carriers to individuals, said data carriers having storing function to store intrinsic data relating to said individuals, said first data carriers being read out said intrinsic data relating to said individuals from outside in non-contact manner;

providing a plurality of second data carriers assigned to groups which are obtained by dividing said plurality of individuals, and which store intrinsic data of said individuals belonging to said groups and permit reading out said intrinsic data of said individuals from outside by radio communication;

retrieving said intrinsic individual data stored in said second data carriers to specify a group to where an objective individual belongs; and

specifying the objective individual by reading out intrinsic individual data from said first data carriers attached to individuals belonging to specified group.

### BRIEF DESCRIPTIN OF THE DRAWINGS

In the attached drawings,

FIG. 1 is a schematic diagram illustrating the structure of an information management system according to the present invention;

FIG. 2 is a schematic diagram illustrating the examples of data read-out/write-in operation in the information management system according to the present invention;

FIG. 3 is a schematic diagram showing an intelligent data carrier used in the information management system according to the present invention;

FIG. 4 is a schematic diagram showing a variation of the information management system according to the present invention;

FIG. 5 is a conceptional diagram showing an overall construction of an information management system according the first embodiment of the present invention;

FIG. 6 is a conceptional diagram showing an overall construction of a wrong dose preventing system according the second embodiment of the present invention;

FIG. 7 is a conceptional diagram showing a main part of the system according to the third embodiment of the present invention;

FIG. 8 is a conceptional diagram showing an overall construction of the system according to the fourth embodiment of the present invention;

FIG. 9 is a conceptional diagram showing an overall construction of the system according to the fifth embodiment of the present invention;

FIG. 10 is a conceptional diagram showing an overall construction of the system according to the sixth embodiment of the present invention;

FIG. 11 is a schematic diagram showing an intelligent data carrier which can be used in the present invention;

FIG. 12 is a schematic diagram showing construction of a agement system as a comparative example; and

FIG. 13 is a conceptional view explaining conventional medical system of the comparative example.

### DETAILED DESCRIPTION OF THE INVENTION

Embodiments of the present invention will now be described with reference to attached drawings.

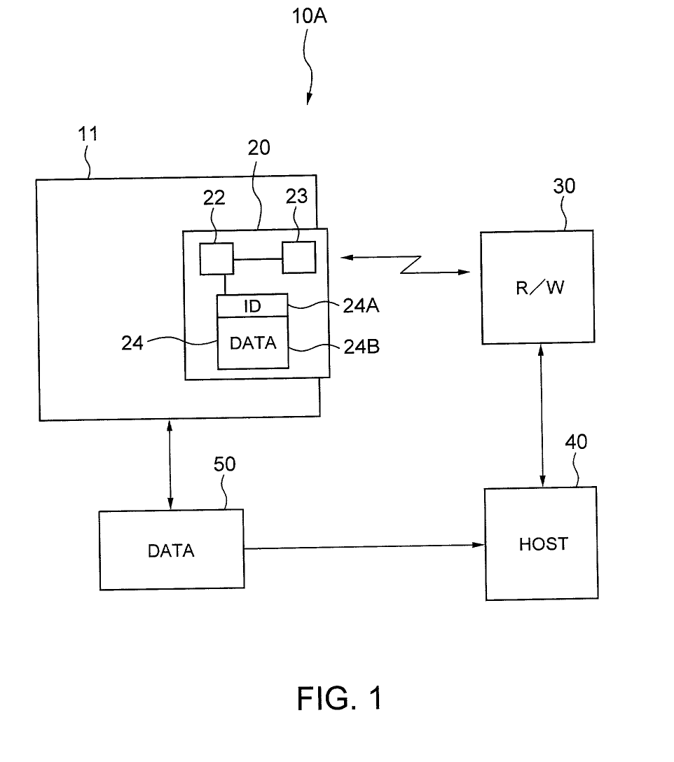

FIG. 1 is a conceptional diagram illustrating the structure of an information management system according to the present invention.

In the information management system 10A of the present invention, an individual 11 carries an intelligent data carrier 20. The individual 11 is the body whose data is to be managed. The individual is , for example, a living body such as a patient in medical facilities, an animals for experiment in research facilities, or other species of organisms.

It is desirable that the intelligent data carrier 20 and individual 11 is integrated, and especially, it is highly desirable that the data carrier 20 is attached to the individual 11 so that their one-to-one correspondence is securely obtained when data is input/output. As explained in embodiments later, the intelligent data carrier 20 can either be buried into the individual 11 or be connected to the individual 11 by some other methods.

The intelligent data carrier 20 has a controller 22, a data communication section 23, and a data storage section 24 therein. The controller 22 is typically an MPU (micro-processing unit), which controls the data communication section 23 and data storage section 24, and executes data computing processing, data transfer, etc.

The data communication section 23 performs the communications relating to data input/output between it and data read-out/write-in (R/W) device 30 provided outside. In this embodiment of the present invention, it is preferable that the data communication is performed by means of non-touching method, specifically, the data communication using radio frequency (RF).

The data storage section 24 includes a storage section 24A which stores an ID of the individual 11 and storage section B which stores the data such as hereditary information and medical information.

The R/W 30 device is connected to a host computer 40 and performs input/output of data between the intelligent data carrier 20 and the RW device 30, and performs computing if necessary.

In addition to this, data 50 relating to the individual 11 is input to the host computer 40 through another channel. The data 50, as will be explained in detail in embodiments, are data such as hereditary data such as hereditary distribution diagram obtained from the individual 11, medical data such as disease history record, or other medical/biochemical data, or data relating to medicine prescription and medical treatment implemented to the individual 11.

Operation of information management system 10 having above-mentioned construction will now be explained.

At first, in the starting stage of the information management, it is sufficient if an ID is stored in the intelligent data carrier 20 attached to the individual 11. The ID can be stored or changed afterwards.

When a data 50, such as body weight, is taken from the individual 11, the data is input to the host computer 40, and computing operation is applied if it is necessary, and further it is transmitted to the intelligent data carrier 20 from the R/W 30. The intelligent data carrier 20 stores the received data in the data storage section 24. Thus the intelligent data carrier 20 can properly store the data of individual 11.

On the other hand, the data stored in the intelligent data carrier 20 of course can be read out by the R/W 30. The data read out will be properly processed and then analyzed in the host computer 40.

A comparative example of the information management system according to the present invention will now be explained.

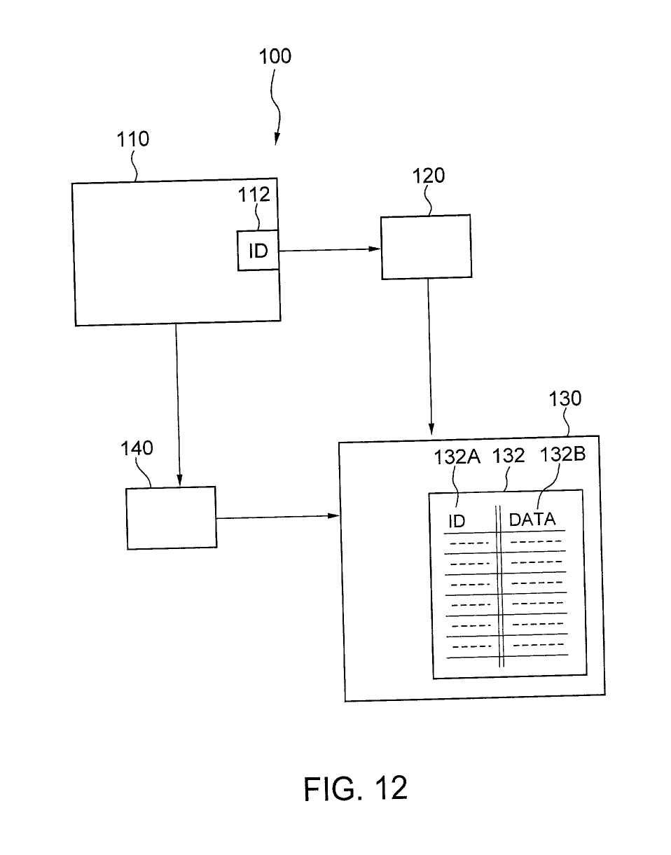

FIG. 12 shows a schematic diagram showing the construction of information management system of the comparative example of the information management system according to the present invention. A management system 100 in this Figure manages data relating to individual 110 at data server 130. Here, the individual 110 is, for example, an animal for experiment in the medical research facilities, or a customer of an apothecary.

The individual 110 has an ID 112 to identify himself/itself. The ID 112 is an individual intrinsic data stored in various kinds of hardware, for example, a bar code, a magnetic card, or an optically readable card. More specifically, a bar code written in a tag which is attached to the animal for experiment is a typical example.

The ID 112 can be other information which specifies the individual, for example, gene information, face, outside appearance or voice other than said individual data stored in the hardware.

The ID 112 is read out by means of a read out means 120 and transmitted to a data server 130. The read out means 120 can be a bar code reader, a magnetic card reader, or an optical card reader. Alternatively, an operator may input the ID 112 to the data server based on the gene information, the face, the outside appearance or the voice of the individual, in the case where the individual is identified according to color and size of the animal for experiment.

The data server 130 has a data table 132 which includes a column 132A for storing IDs of various individuals and a column 132B for storing the individual data corresponding to the IDS. If the data server 132 receives a new ID which is not registered in the data table 132, this new ID can be added in the data table 132.

On the other hand, the intrinsic data 140 relating to the individual is taken and input to the data server 130 at the same time when identifying the ID of the individual explained above, or independently. The intrinsic data relating to the individual includes, for example, biochemical data of the animals for experiment, purchase data of customers who have IDs. These kinds of data are input to the data server 130, processed properly if necessary, and stored in the data column 132B which corresponds to the identifying IDs of the individual.

As detailed above, in the conventional information management system, the individual is attached with ID only; the intrinsic data relating to that individual is stored and managed by a specified data server.

However, in the comparative example of information management system, as shown in FIG. 12, there is a problem that accesses to data are extremely limited since the intrinsic data 140 relating to the individual is stored in the specified data server 130. That is, it is limited to the specified data server 130 that can access to the data 140 and read out and update. It is necessary for the individual 110 is in the place where the specified data server is located when the individual wishes to read out or renew data of himself/herself.

A practical example is explained as follows. Supposing that the individual 110 is a patient, if he/she wants to investigate his/her past medical history and treatment history, he/she must go to the medical facilities where the data server storing such data is installed, and thus he/she can not access the data at other places where the data server is not installed.

In other words, for the data of the individual 110, only the medical facilities that have the data server 130 own the actual access right, thus the information is in a very closed status.

In contrast, according to the information management system according to the present invention, as shown in FIG. 1, the data of individual 11 is together with the individual 11, making the data can be readable and renewable whenever and wherever they are needed as far as there is a R/W 30. If the individual 11 is a patient, he/she can read out and renew his/her medical and treatment histories when needed at all medical facilities where the R/W 30 is installed. That is, the data of individual 11 is in a very “open” status.

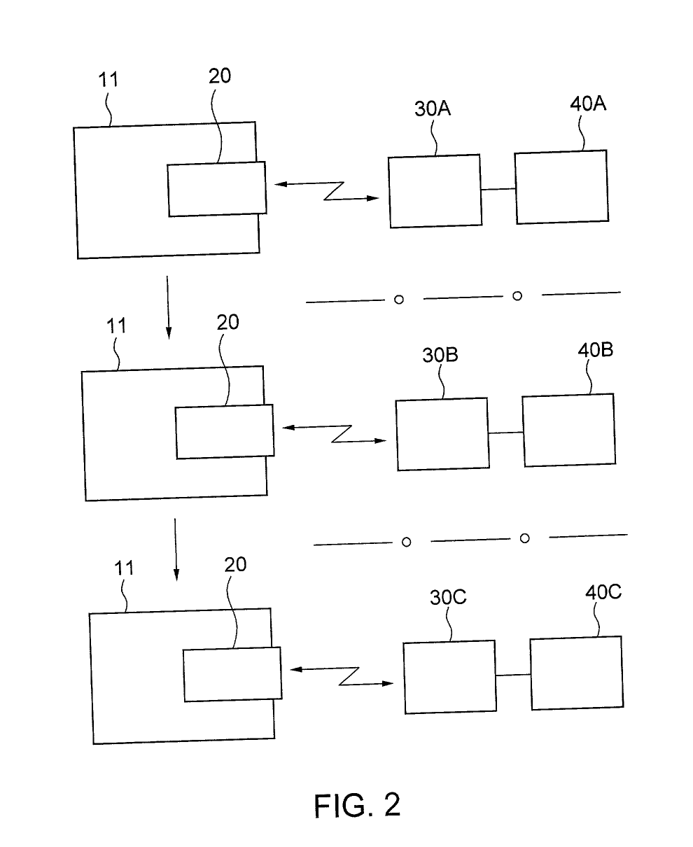

FIG. 2 illustrates the conceptional diagram showing various forms of the data read-out/write-in pattern in the information management system according to the present invention. The data stored in the intelligent data carrier 20 attached to the individual 11, such as people and animal, is reads out/written by a first R/W 30A and a first host computer 40A. Then, the individual 11 can move freely around the specified space, and the data which is stored in the intelligent data carrier 20, can be read out and updated, if necessary, by a second R/W 30B and a second host computer 40B, or a third R/W 30C and a third host computer 40C, etc According to the present invention, the data stored in the intelligent data carrier 20 can be accessed freely at anytime and anywhere provided that there is a data readout/write-in device 30.

Furthermore, according to the present invention, it becomes difficult for the data to be mistaken because the individual 11, himself/itself, brings the data that is stored in the intelligent data carrier 20. That is, for the system in comparative example as illustrated in FIG. 12, if the ID of the individual 110 is mistaken, the data can be written in to the other individual's column in table 132. Contrary to this, for the management system according to the present invention, since the data of individual 11 is always stored in the intelligent data carrier 20 which is attached to the individual 11, there is little possibility about such kind of ‘data mistaking’.

Furthermore, since the individual 11 can accumulate the data and bring such data by himself/herself, he/she can manage his/her medical and treatment histories through the lifecycle. For example, sometimes, the disease and treatment records of one's childhood are very important for the later treatment intervention. In such a case, according to the present invention, the medical records can be stored securely in the intelligent data carrier, and thus they can be read out later, making the next treatment to be performed very accurately and efficiently.

Besides, according to the present situation, the information of medical records usually is destroyed after a certain obligated keeping time. Contrary to this, according to the present invention, it becomes possible to avoid the situation in which the information of medical records is deleted from the server in the hospital after exceeding the predetermined obligated keeping time and access after the deletion becomes impossible.

Furthermore, according to the present invention, the intelligent data carrier 20 can be made intelligent.

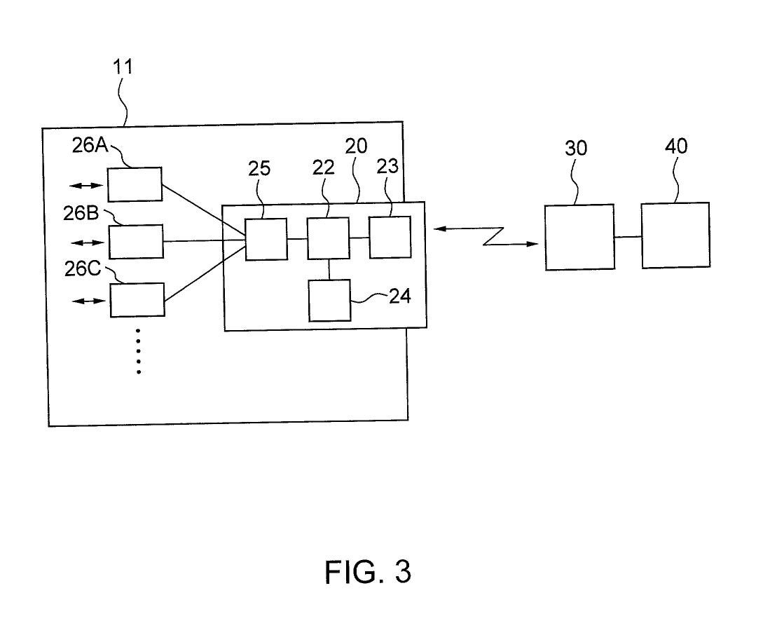

FIG. 3 shows the conceptional view of the construction of the intelligent data carrier of the information management system according to the present invention. In this Figure, the same reference numerals are used for those elements that are the same as those in FIGS. 1 and 2, and thus the detail explanations thereof will be omitted.

In FIG. 3, the intelligent data carrier 20 has an interface (with physical input/output function) 25 which is connected to the controller 22. Various external apparatuses 26A, 26B, . . . , can be connected to the interface 25. Those external apparatuses are, for example, a temperature sensor for measuring the temperature of the individual 11, or an actuator that gives the physical action against to the individual 11, or a dispenser which dispenses medicine for the individual 11, or a speaker that gives information to the individual 11 by voice, or a microphone that collects the voice of the individual 11.

In other words, through these external apparatuses 26A, 26B, . . . , the interface 25 can obtain the specified data from the individual 11, or perform the specified physical or chemical processing, or give the information. For example, the interface 25 measures the blood-sugar level of individual 11, and then prescribes insulin for the individual 11 according to the measuring result; or the interface 25 measures the blood pressure of individual 11, and then prescribes antihypertensive for the individual 11.

The data obtained from the individual 11 is processed properly in the controller 22 if necessary, and stored in the storage section 24. When the individual 11 is subjected to some treatments using the external apparatus 26, the data will be stored in the data storage section 24 according to the necessity. And the stored data can be taken out through the R/W 30 if necessary.

As explained above, if the intelligent data carrier is used, as shown in FIG. 3, the technical effect that not only managing the intrinsic data relating to the individual 11 centrally but also enabling acquisition of various kinds data in anywhere and at any time and performing various treatment to the individual 11. The individual 11 is liberated from the electric wirings used for taking out data, or from the pipe for prescribing medicine, and can freely move around the specified space. At the same time, a so-called ‘on-site observation’ can be performed and also obtaining various biochemical data from the individual 11 in movement can be performed in extremely smooth manner.

Next, a variation of the information management system according to the present invention.

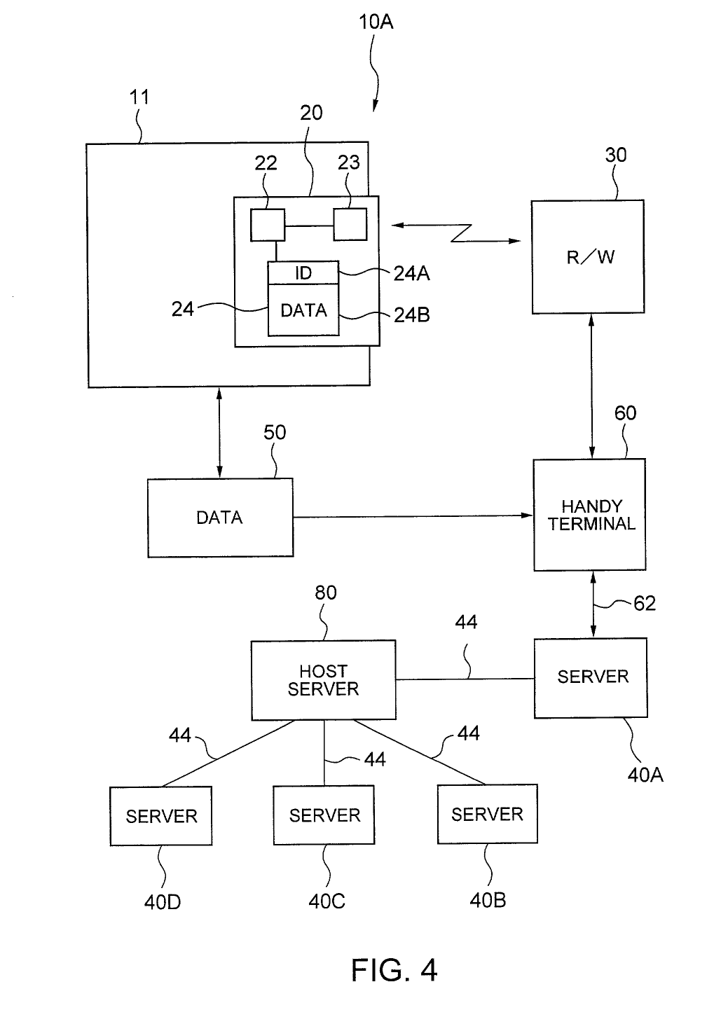

FIG. 4 shows the conceptional view of the variation of the information management system according to the present invention. In this Figure, the same reference numerals are used for elements that are the same as those in FIG. 1-3, and thus the detail explanations thereof will be omitted.

In the system 10B shown in FIG. 4, the data readout/write-in device 30 is connected to a handy terminal 60 of portable type and is controlled by the handy terminal 60. The R/W 30 and the terminal 60 can be integrated.

In this variation, the reading out and the updating of data from the intelligent data carrier 20 are performed at the terminal 60. That is, the terminal 60 can read out data from the intelligent data carrier 20, or to write in data 50 obtained from the individual 11 to the intelligent data carrier 20.

Furthermore, terminal 60 can transfer the obtained data to the server 40A. A data communication link 62 provided between the terminal 60 and the server 40A may be either cable means or wireless means, or it can be an infrared ray link. The server 40A which has received data from the terminal 60, can forward the data to a host computer server 80 through network circuit if necessary. Moreover, this data can be forwarded to other servers 40B-40D, if necessary.

As described above, data obtained and updated at the terminal 60 can be shared by a plurality of servers 40A-40D.

According to this variation, since the data stored in the intelligent data carrier 20 can be read out and updated at the handy terminal 60, the individual 11 can act without binding to the server 80 by wirings. That is, in order to read out/update the data, the individual 11 need not go to the place where the server 40 is located. And provided that there is a handy terminal 60, the reading out/updating of data can be performed at anytime and in anywhere.

For the handy terminal 60, an exclusive one which is specialized to the function needed by the system 10B can be used. Other terminal such as a mobile type personal computer, and various types of PDA (personal data assistant) can also be used.

Now, some preferred embodiments according to the present invention.

(Embodiment 1)

First, an information management system for medical records of patients will be explained as a first embodiment of the present invention.

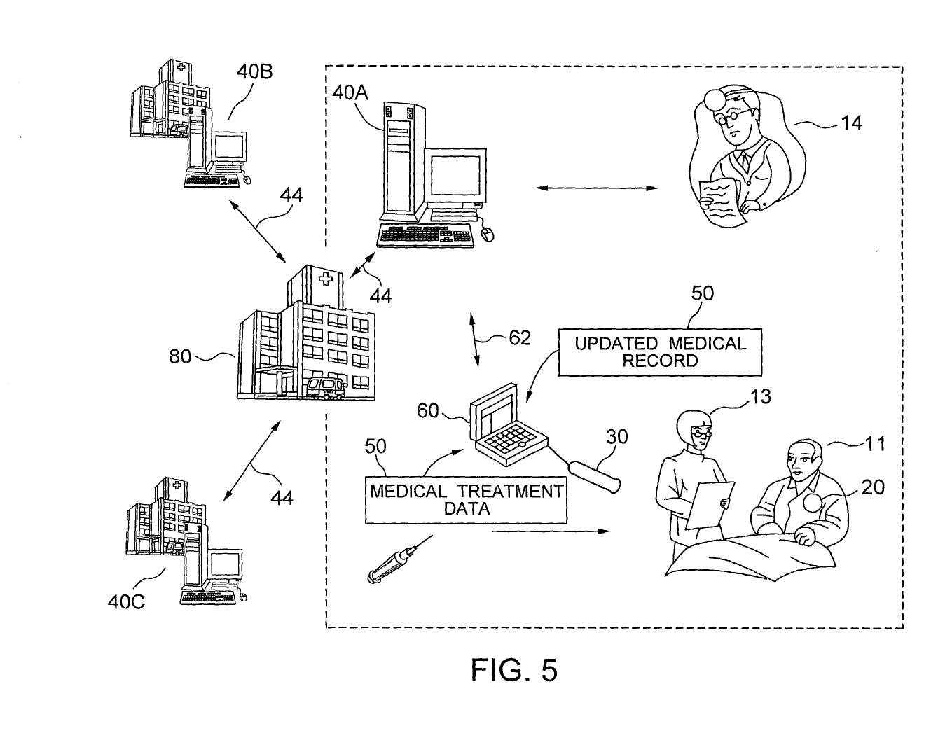

FIG. 5 is a conceptional diagram showing overall construction of information management system according to the first embodiment. In this Figure, the same reference numerals are used for those elements that are the same as those in FIGS. 1-4, and detailed explanations thereof will be omitted.

The system illustrated in FIG. 5 stores the medical records of the patient 11 in the intelligent data carrier 20 which is attached to the patient 11 and manages the data. The intelligent data carrier 20, for example, can be made several millimeter long capsule-shaped, which can be buried into the body of patient, or can be dangled from the neck or wound around the arm or foot. The intelligent data carrier 20 stores the medical records of patient, such as disease history, medical data, and medical treatment. Such data holding by patients is distributed management of medical records.

The patient 11 can be a hospitalized or an outpatient. The patient 11 stores his/her medical records in the data carrier 20 and always has them attached. When the patient 11 goes to hospital, firstly, he/she can read out the medical records stored in the intelligent data carrier 20 by the data read-out/write-in device 30 controlled by the terminal 60 in the hospital. Doctors and nurses can determine and perform examinations and prescribe medicines with reference to these medical records. These medical practices can be written into the intelligent data carrier 20 through the terminal 60. That is, the data can be added to the medical records. Thus, the patient 11 can have the medical records of himself/herself, in which the newest medical records are always contained.

On the other hand, the newest medical data that has been read out from/added in the intelligent data carrier 20 by the terminal 60 can be transferred to the server 40A located in that hospital through the specified communication link 62, and can be managed there. The doctor group 14 can read out those medical records from the server 40 when needed, and can decide the treatment policy based on the newest data.

Furthermore, the medical records stored in server 40A can be transferred to the server 40B, 40C, . . . , which are located in other medical facilities, through a host computer server 80 and a network circuit 44. Thus, medical records are co-managed and the other medical facilities can also obtain the newest medical records of the patient 11, and thus can perform medical treatments quickly and discuss the treatment policies.

According to this embodiment, the medical treatment can be performed accurately and quickly because the patient 11 can bring his/her medical records that always contain the newest data.

That is, the patient 11 can keep the medical records of himself/herself through lifecycle and receive medical treatments accurately reflecting the medical histories.

Furthermore, according to this present embodiment, the medical records can be shared within a wide range, exceeding the limitation from various departments and medical facilities. For example, at present, even within the same medical facility, sometimes, it is not easy for the department of pediatrics and the department of internal medicine to share the medical records of patients. However, according to this embodiment, since the medical records is attached to the patient 11, they can be read out immediately by other departments, and the appropriate treatment can be performed. Even when the patient 11 goes to other medical facilities, it is similar as above, the medical records can be read out immediately, and he/she can receive the appropriate treatment in those medical facilities.

Besides, the medical mistakes (human errors in medical procedures) caused by mistaking of records' can be prevented according to this embodiment. That is, because the medical records is stored securely in the intelligent data carrier 20 of the patient 11, there should be no possibility for occurring mistaking provided that the records are read out from the data carrier 20.

On the other hand, the newest medical data that has been read out from/added to the intelligent data carrier 20 by the terminal 60 is transferred to the server 40 located in that hospital through the specified communication link 62, and can be managed there. The doctor group 14 can read out those medical records from the server 40 if necessary, and can decide the treatment policy based on the newest data.

Furthermore, the medical records stored in the server 40A can be transferred to the server 40B, 40C, . . . , which are located in other medical facilities, through the host computer server 80 and the network circuit 44. Thus, other medical facilities can also obtain the newest medical records of the patient 11, and can perform medical treatments quickly and discussion for the treatment policies.

As it will be described later in the third embodiment, a new function can be added to the intelligent data carrier, such as measuring the biochemical data of patient 11, or performing physical/chemical process against to the patient 11, etc

(Embodiment 2)

The second embodiment of the present invention which is the prescription error preventing system utilizing the information management system is described.

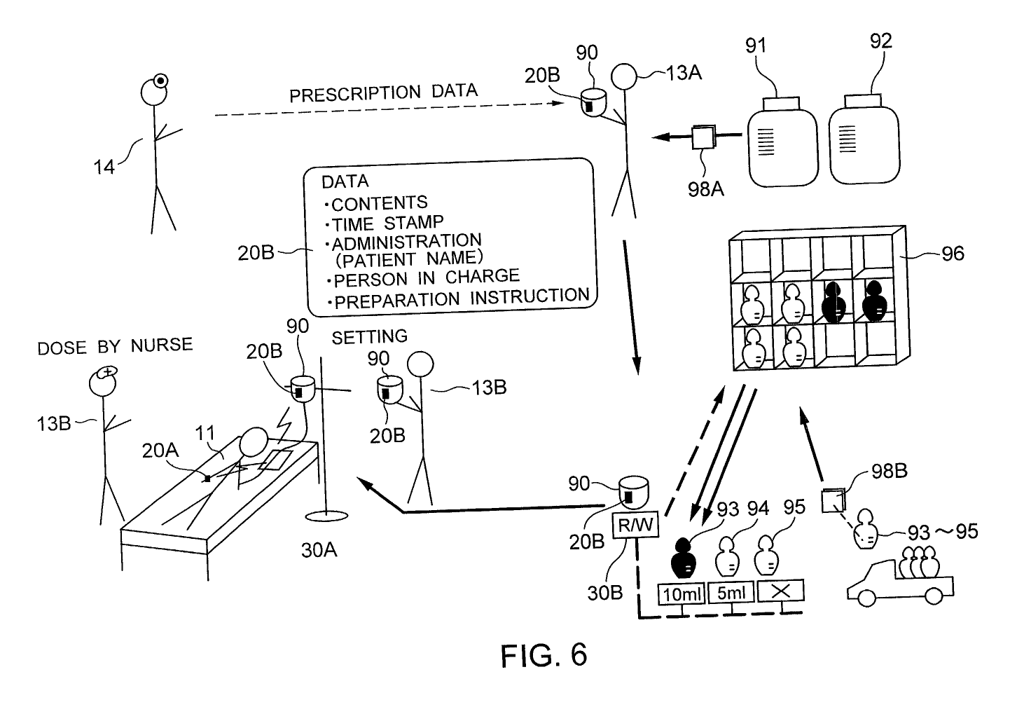

FIG. 6 is a conceptional diagram showing the overall construction of the prescription error preventing system according to this present embodiment. In this Figure, the same reference numerals are used for elements that are the same as those in FIGS. 1-5, and the detailed explanations thereof will be omitted.

The system illustrated in FIG. 6 can accurately prepare medicines prescribed by the doctor 14 according to the symptom of the patient 11, and can guarantee the accurate matching between the prepared medicines and the patient 11.

In this system, the prescription data prescribed by the doctor 14 is transferred to and written in the data carrier 20B. This prescription data can include, for example, contents of medicines, time stamp, person in charge, name of patient 11 to whom the medicines should be given, prescription date, prescription instruction, etc. The pharmacist 13A who received data carrier 20B, prepares the medicine 90 accurately based on those data. Furthermore, the data carrier 20B is stuck to the medicine container 90 that contains prepared medicine, making them in an integrated status.

The specified nurse 13B doses the medicine 90 prepared above to the patient 11 according to the directing data stored in the data carrier 20B. Then, at this time, the read out device 30A which is set in the bed of the patient 11 or carried by the nurse 13B, will confirm the data in the data carrier 20A of the patient 11 and the data of medicine 90 from the data carrier 20B. Only in a case where they are matched accurately, the delivery permission will be given to the nurse 13B. In more detail, for example, if data in the data carrier 20A and 20B do not match, the alarm will ring, or the medicine case will not be opened. Thus, since final check before dose of medicine is performed automatically, the medical mistakees, such as prescription error and mistaking medicines of the patient can be actually prevented.

Furthermore, when the pharmacist 13B prepares medicine 90, the accuracy can be guaranteed by using the information stored in the data carrier 20B. For example, the pharmacist 13B can accurately select the appropriate one from the two base solutions 91 and 92, that is managed by the bar code managing system 98A, based on the data in the data carrier 20B delivered from the doctor 14. Then, the data in the data carrier 20B can be read out by the R/W 30B, and only the necessary amounts of necessary medicines among medicines 93, 94, 95, etc, which are stored in the auto-storehouse 96, are selected and prepared. By combined-using of such kind of automatic preparing system, the artificial miss relating to the medicine preparation can be securely prevented. Meanwhile, in the auto-storehouse 96, new inventory control and quality control by using the barcode controlling system 98B can be introduced. That is, the stock amounts, the records of using, and the keeping preserve times of the medicines 93-95 can be managed by this kind of barcode managing system 98B. If necessary, it can be also made to perform supplementation, addition, and abandonment of medicines automatically.

(Embodiment 3)

As a third embodiment according to the present invention, an individual information measuring/status controlling system using the intelligent data carrier is described.

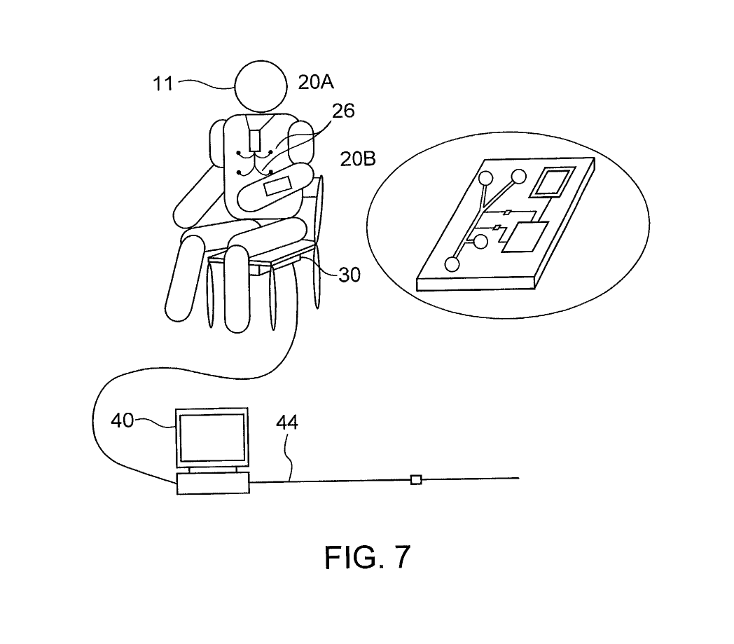

FIG. 7 is a conceptional diagram showing the main part of the construction of the individual information measuring/status controlling system according to this embodiment. In this Figure, the same reference numerals are used for those elements that are the same as those in FIGS. 1-6, and the detailed explanations thereof will be omitted.

In this embodiment, the patient 11 brings the intelligent data carrier 20. In FIG. 7, the example shows the case of attaching the intelligent data carrier 20 at chest and arm. The data carrier 20A is a moving body monitor suspended from neck, such as electrocardiograph, thermometer, blood pressure gauge, etc. And data carrier 20B is a moving body monitor or a dose device stuck on the arm by wetware assembly.

In fact, there is no need for attaching two intelligent data carriers, either of the two carriers is sufficient. Besides, it can be attached at the other positions besides at the chest and the arm.

This kind of intelligent data carrier 20 can measure the temperature, the blood pressure, the electrocardiogram and acquire the data of the patient 11 through a build-in interface and the external apparatus 26. Besides, it can also monitor the living body and prescribe medicines according to need.

For example, the intelligent data carrier 20 can measure the blood pressure of the patient 11; when the measured data exceeds the specified level, the intelligent data carrier 20 can prescribe the antihypertensive for the patient 11. Furthermore, it can also prescribe insulin for the patient 11 at the proper time with monitoring his/her blood-sugar level.

In the detailed example shown in FIG. 7, the R/W 30 is placed under the chair of the patient 11. The R/W 30 performs communication with the intelligent data carrier 20 and read-out/write-in the data through RF signal. Besides, the R/W 30 can also be placed under the bed or other locations (not illustrated in this Figure) close to the patient.

Measurement for living bodies and the medicine prescription by the intelligent data carrier 20 can be performed according to the program installed in the data carrier itself; or they can be performed according to the directions from the server 40 through the R/W 30. Alternatively, a program can be forwarded to the intelligent data carrier 20 from the server 40, and the intelligent data carrier 20 can perform the measuring of living body and prescribing of medicine according to this program.

In addition to technical effects obtained by the first and second embodiments, the following technical effects can be obtained according to this embodiment.

First, according to this embodiment, the living body data of the patient 11 can be measured regularly by the intelligent data carrier, and then, these living body data can be stored in the intelligent data carrier. Thus, the patient 11 to can receive 24-hour measurement by means of the wireless way.

Furthermore, according to this embodiment, when living body data measured by the intelligent data carrier exceeds the critical value, the alarm may be transmitted to the server 40 through the R/W 30. That is, conditions of the patient 11 can be monitored regularly around-the-clock by means of the wireless way.

Furthermore, according to this embodiment, since the intelligent data carrier 20 can measure living body data of the patient 11 and prescribe medicine for him/her if necessary, the extremely careful treatment in response to the conditions of the patient 11 can be performed automatically. Besides, the patient 11 can move freely because the wiring for measuring of living body data and the pipe for prescribing of medicine need not be removed. It is also possible to persuade reexamination for a patient whose bad condition is detected.

Thus, with the use of the intelligent data carrier 20, the conditions of the patient 11 can be monitored continuously, and the emergent situation can be appropriately responded, and symptomatic treatments can be performed rapidly and correctly.

Furthermore, the living body measurement system of this embodiment can be used not only by medical facilities, such as hospitals, but also in-home treatment. That is, even the patient 11 does not go to hospital for the diagnosis from a doctor, the intelligent data carrier 20 can alarm when abnormality is detected, and perform proper treatment, such as prescribing medicine, etc. because it is attached to the patient 11 and monitors his/her living body conditions around-the-clock.

(Embodiment 4)

An example where an individual information measuring/status controlling system using the intelligent data carrier of the present invention is applied to the medical system will be described.

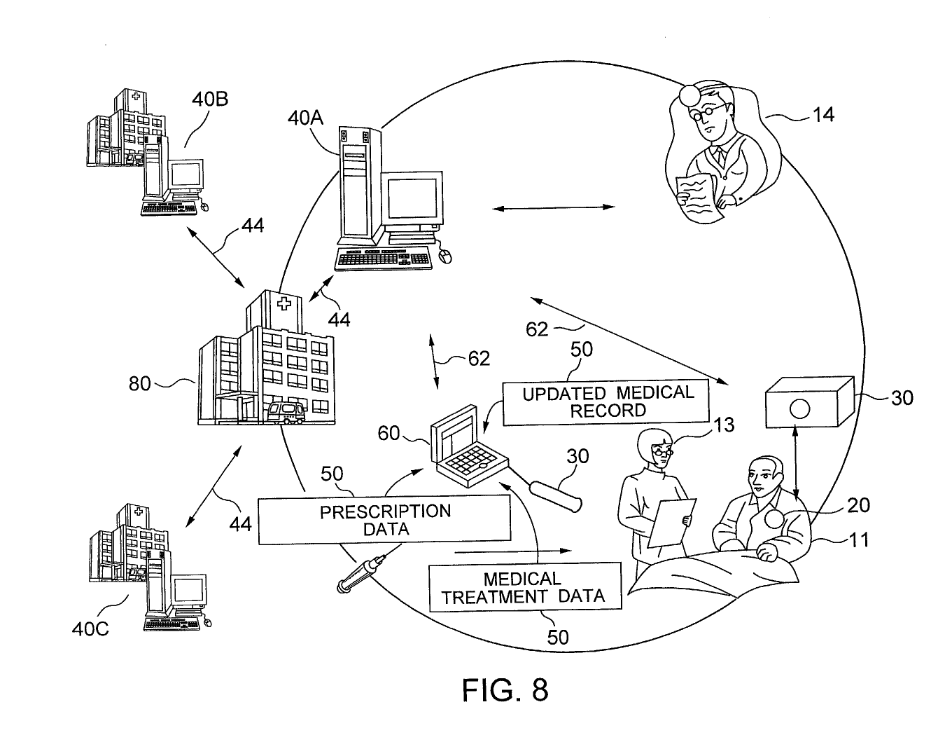

FIG. 8 is a conceptional diagram showing the overall construction of the individual information measuring/status controlling system according to this embodiment.

In FIG. 8, the same reference numerals are used for elements that are the same as those in FIGS. 1-7, and thus the detail explanations thereof will be omitted.

In the system shown in FIG. 8, the patient 11 can be a hospitalized or an outpatient. The patient 11 saves his/her medical records in the data carrier 20 and always carries them attached. Such medical records kept by patient is distributed information management. When the patient 11 goes to hospital, firstly, he/she can read out the medical records stored in the intelligent data carrier 20 by the data read-out/write-in device 30 controlled by the terminal 60 in the hospital through communication link 62. Doctors and nurses can perform examinations and prescribe medicines with reference to those medical records. Besides, as describe above concerning the embodiment 3, the data carrier 20 measures the living body data of the patient 11 of his/her daily life, which may be read out and used when doctors and nurses perform medical practices. Furthermore, the data carrier 20 can also perform the prescribing of medicines based on these living body data in the daily life except for the case when the patient 11 receives medical practices in medical facilities.

These medical practices mentioned above can be written into the intelligent data carrier 20 through the terminal 60. That is, the data can be added to the medical records. As a result, the patient 11 can have the medical records of himself/herself, in which the latest medical records are always contained.

Furthermore, with the use of intelligent data carrier 20, the conditions of the patient 11 can be monitored continuously, and the emergent situation can be responded properly, and the symptomatic treatment can be performed rapidly and correctly.

(Embodiment 5)

As a fifth embodiment according to the present invention, an example in which the information management system according to the present invention using the intelligent intelligent data carrier is applied to an in-home medical.

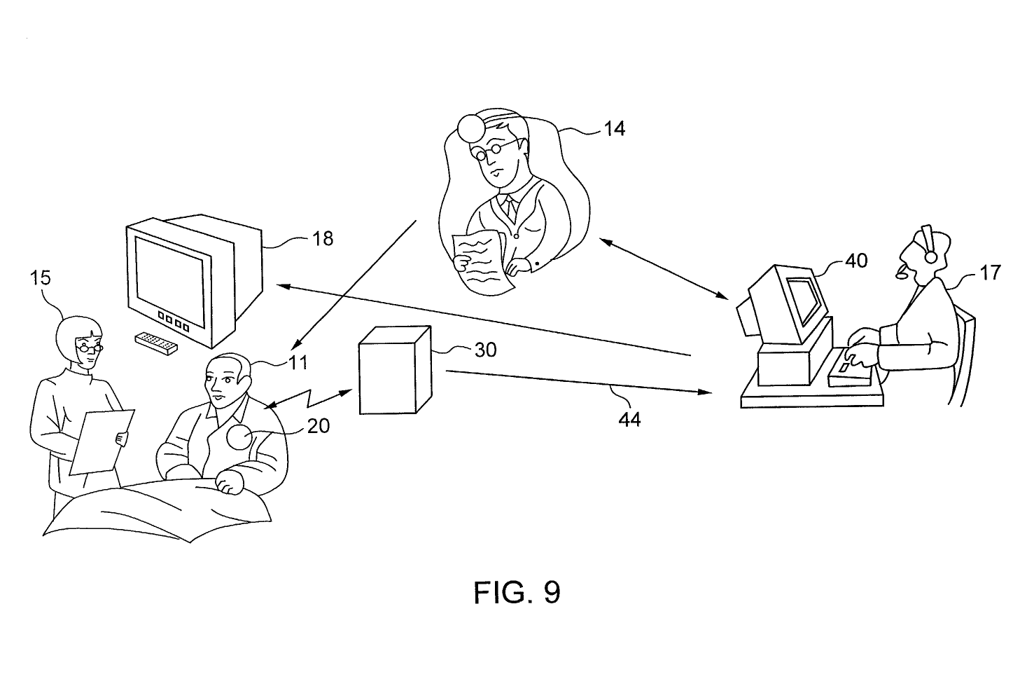

FIG. 9 is a conceptional diagram showing the overall construction of the information management system of this embodiment.

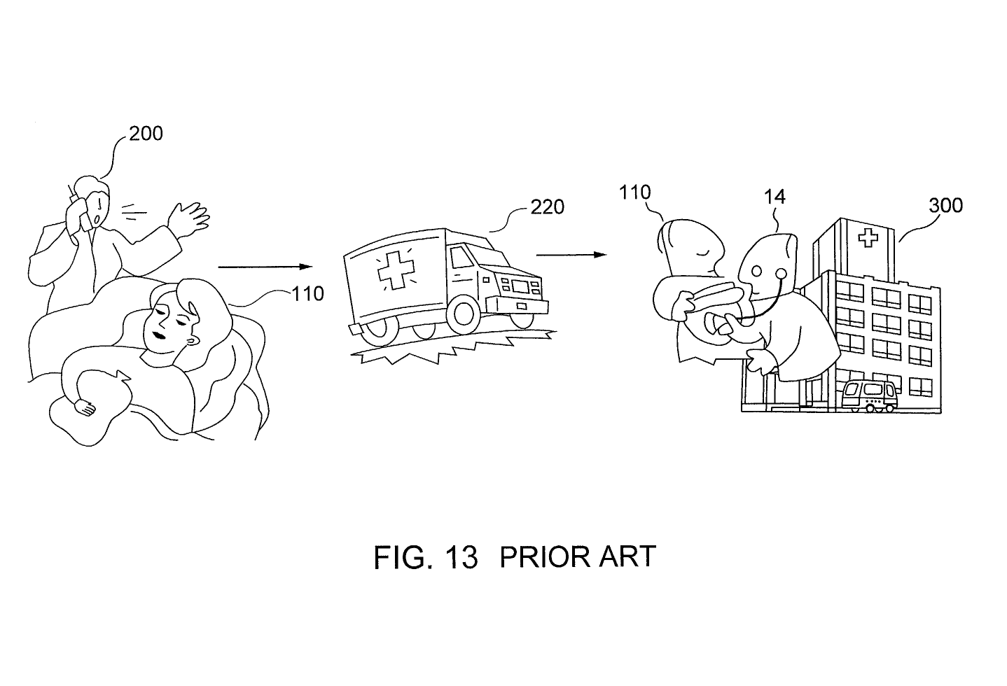

And FIG. 13 is conceptional diagram showning the conventional medical system which is referred to as the comparative example.

In these Figures, the same reference numerals are used for elements which are the same as those in FIGS. 1-8, and thus the detailed explanations thereof will be omitted.

Firstly, the conventional medical system will be explained with reference to FIG. 13.

Conventionally, for example, if the emergency case happens, it has been usual that: first, the nursing person 200 makes the emergent contact by phone, then the ambulance comes and takes the patient 110 to medical facility 300, where the patient 110 receives diagnosis and treatment from the doctor 14.

In contrast, in the information management system according to the present invention shown in FIG. 9, the in-home patient 11 is attached with the intelligent data carrier 20, which has the function of measuring living body data of the patient 11 as explained in FIG. 3.

The R/W 30 is provided in vicinity of the patient 11, which enables RF communication with the intelligent data carrier 20. The R/W 30 is also connected to the server 40 located in in-home medical center through the network circuit 44. When the living body data of the patient 11 measured by the intelligent data carrier 20 is found abnormal, the abnormality will be sent to the server 40 in in-home medical center immediately and the operator 17 will contact with the doctor 14 nearby. The doctor 14 who received the contact will run to the place where the patient 11 is and can perform proper treatment speedily. Besides, the operator 17 of the in-home medical center who has received the emergency contact can give directions to the nursing person 15 through other cable TV 18. Thus, the proper treatment can be ensured before the doctor 14 arrives.

The judgment of the abnormality of living body data of the patient 11 is performed according to a built-in program in the intelligent data carrier 20. In such case, this program can be forwarded from the server 40 to the intelligent data carrier. Besides, the intelligent data carrier 20 can send the living body data of the patient 11 to the server 40, where judging of the abnormality is to be performed.

According to this embodiment, a fast and efficient in-home medical system can be established by the communications through the network circuit between the in-home medical center and the patient who is attached with the intelligent data carrier.

Namely, in-home medical center manages in-home medical database and deal with emergency call. Furthermore, the in-home medical center daily reports health status of a patient and make emergency call to a doctor nearby.

(Embodiment 6)

As a sixth embodiment of the present invention, an example in which the information management system according to the present invention is applied to manage the mice for experiment is described.

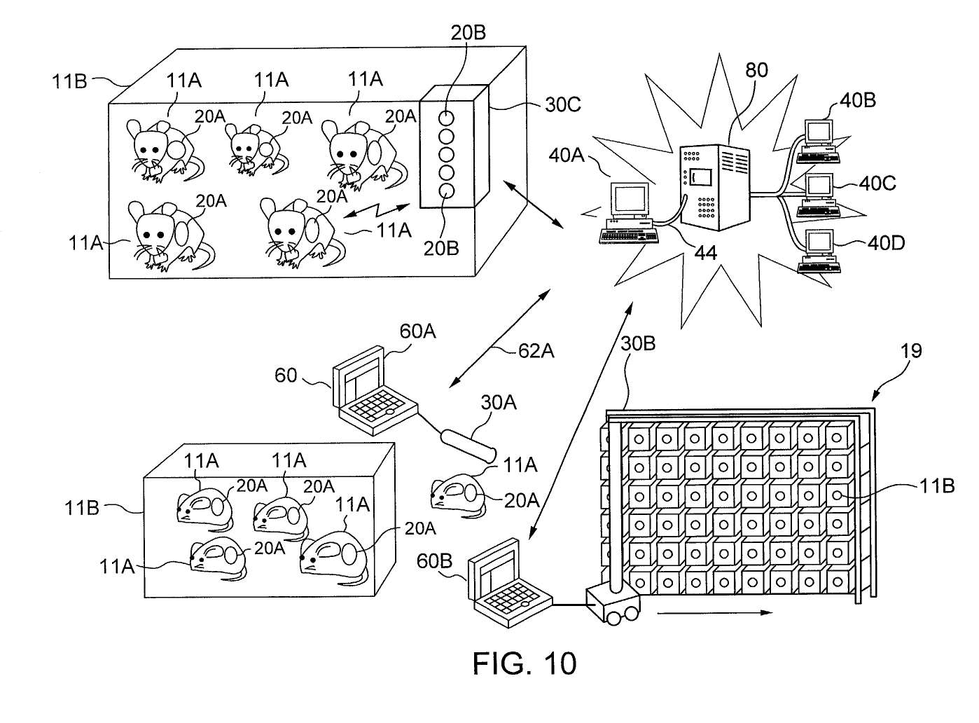

FIG. 10 is a conceptional diagram showing the overall construction of the information management system of this present embodiment. In this Figure, the same reference numerals are used for elements that are the same as those in FIGS. 1-9, and the detailed explanations thereof will be omitted.

In medical related research facilities, raising and managing of very many mice A for experiment is always necessary. According to the system according to the present invention, a super-small type intelligent data carrier 20A is buried into the body of every mouse 11A. Data relating to the ID (identification) information for identifying every mouse, and the ID of the cage 11B where that mouse is stored, and the age, the sex, the hereditary information of the mouse as well as various experimental records, etc, is stored in this intelligent data carrier 20A, and it can be read out and updated from outside by RF communication.

Every specified cage 11B accommodates predetermined number of mice 11A, and is attached with the intelligent data carrier 20B. Besides, the R/W 30C is also provided for reading out/writing in data to the intelligent data carriers 20A and 20B.

The intelligent data carrier 20B stores the ID information of that cage and the data relating to the mouse/mice 11A in that cage. The data can be, for example, the ancestry name of the mouse/mice, the hereditary information such as sex, age, reproduction record, ancestry diagram, and the experimental record, etc.

The cage 11B is held in a cage rack 19, and can be taken out if necessary. A movable antenna 30B is provided at the cage rack 19, which enables the RF communication between the cage rack 19 and the intelligent data carrier 20B of every cage. That is, the reading out and updating of the data stored in the intelligent data carrier 20B of every cage can be performed through the movable antenna 30B. These data can also be sent to the server 40A through the communication link 62B from the terminal 60B, and can be forwarded to the host computer server 80 and other server 40B, etc through the network circuit 44 if necessary. According to this embodiment, the every-cage information management has become possible.

On the other hand, the reading out and updating of the data stored in the intelligent data carrier 20A, which has been buried in the mouse 11A, can be performed ‘mouse by mouse’ from the R/W 30A. In such a case, use of a handy terminal 60A will bring much convenience, as shown in FIG. 4. These data can be sent to the server 40A through the communication link 62A, and can also be forwarded to the host computer server 80 and other server 40B etc through the network circuit 44 if necessary.

According to this embodiment, a large number of data from mice will have good correspondence to each of the mouse and can be accurately managed. A specified mouse can also be accessed quickly and accurately. That is, when a mouse 11A to be examined or tested is pecified by the server 40A, the server 40A will find out the ID of the cage 11B which stores that mouse by searching the database. Then, the server 40A sends the ID to the terminal 60B, and searches for cage 11B which has that ID by making the antenna 30B move. When the objective cage 11B is found, distinguishing display or operation will be performed so that the cage can be distinguished easily. After that, the objective mouse can be found quickly through investigating of the mice in that cage by using the handy terminal 60A and R/W 30A.

Furthermore, in this embodiment, it is possible to perform communication between the data of intelligent data carrier 20A of mouse and the data of intelligent data carrier 20B of the cage though the use the R/W 30C. Thus, for example, the ID information and other data of mouse 11A can be transferred to the intelligent data carrier 20B of the cage 11B. As a result, the data transferred in such a way can be read out automatically with the antenna 30B. That is, even mouse 11A is arbitrary arranged in any of the multiple cages 11B, the system can detect automatically that which mouse is now in which cage, and then make out a database automatically.

Furthermore, if the living body measuring function, as explained in FIG. 3, is added to the intelligent data carrier 20A of the mouse, the living body data of every mouse can be obtained automatically, and then written into the server 40 from antenna 30B through intelligent data carrier 20B of the cage. That is, the measuring and managing of a great number of data of the mice for experiment can be performed automatically. As the result, even if the mixing or the escaping of the mice resulted from miss or accident during working happens, the original management state can be restored by reading out the data buried in the body of every mouse.

Furthermore, if there is some change in the status of mice, for example, there is a mouse seems to die before long, the intelligent data carrier 20A of that mouse can detect this condition and contact with the intelligent data carrier 20B through the R/W 30C, then the intelligent data carrier 20B can raise an alarm.

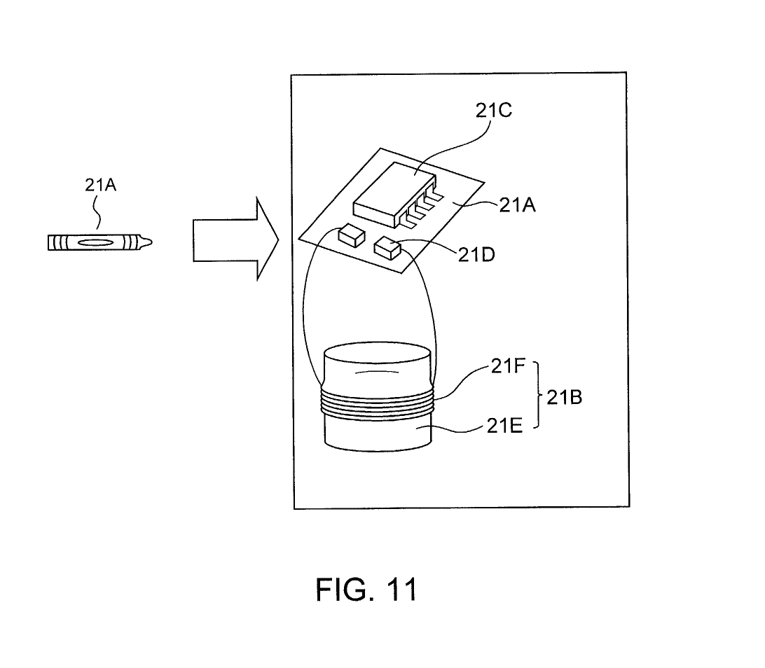

FIG. 11 illustrates conceptional view of construction of the intelligent data carrier that can be used in this embodiment and embodiments 1-5 explained above. The intelligent data carrier 20A can be made capsule-shaped of several millimeter long. In the inner part, a substrate 21A and an antenna part 21B are inserted. On the substrate 21A, a RF-ID chip 21C and a condenser 21D are assembled. In the antenna part 21B, coil 21F can be made to wind around the core 21E by a predetermined turns.

The power needed by the intelligent data carrier 20A can be supplied by rectifying the RF signals sent from the external data R/W device through the rectifying circuit provided in the RF-ID chip 21C. That is, because the power for intelligent data carrier 20A is supplied from outside, any power supply such as battery is not needed. Thus, the intelligent data carrier 20A can be made very small and light.

Alternatively, as for the power supply for the intelligent data carrier, various supply source such as various kinds of batteries, solar battery, means for transforming from individual temperature to the power, and means for transforming kinetic energy by movement of the individual to the power, can be used.

When such a super small type intelligent data carrier 20A is used to manage the ID data and take out the living body data of the mouse 11A, since the mouse can move freely, there comes an advantage of that the experimental data can be obtained in a condition which is very close to the natural one. That is, conventionally, in order to obtain the living body data of the mouse, it is necessary to connect wire or pipe to the mouse for obtaining data, thus actions of the mouse are greatly limited. As the result, the case such as the data obtained is different from the natural situation can take place.

Contrary to this, according to this embodiment, because the mouse can move around freely, the great effect can be obtained when the living body data concerning moving is needed.

Thus, embodiments of the present invention have been described with reference to the practical examples. However, this present invention is not limited to those examples. For example, the information management system according to the present invention may be applied to ecological investigation of the migratory bird. More specifically, by attaching the intelligent data carrier to the migratory bird, and monitoring at the specified place, the ecological data such as flying pathway and period of the migratory bird can be investigated accurately and easily.

Furthermore, the present invention can be applied for the purpose of managing the intrinsic data relating to all living individuals other than mankind and animals and thereby remarkable effect will be obtained.

Furthermore, for example, the present invention can be applied for the managing of the lifecycle of the automobile. At this situation, the automobile is attached with the intelligent data carrier, in which the data relating to the designing and producing of that automobile, data relating to the periodical inspection and maintenance, or data relating to the accident repair is stored; and the data can be added and updated if necessary. Thus, the maintenance and repair for the automobile can be performed accurately and speedily; furthermore, the distinguishing of the harmful materials and recyclable parts can be performed accurately when disposing of it.

As detailed above, according to the present invention, because it is the principle that the individual is attached with the intelligent data carrier in which the data of the individual itself is stored, the data can be stored with accurately correspondent to the individual, and actively used. As a result, the missing and the mistaking of data can be prevented.

Besides, the data can be accumulated by adding and updating of it in turn, and the data can be managed and used through lifecycle.

Furthermore, when it is applied to manage animals for experiment, it can manage a large number of individuals automatically, accurately and easily.

Furthermore, if the intelligent data carrier is connected to a specified external apparatus through interface, the biochemical data relating to the individual can be obtained automatically, and the treatment such as prescribing of medicine can be performed.

In other words, the information management that is essentially different in quality from the conventional one can be realized, and it has many advantages for the industries according to this present invention.

What is claimed is:

1. An individual information management system to manage individual data comprising:
a data carrier which is attached to said individual, and which stores data relating to said individual, and an external device to read out data stored in said data carrier and write in new data in said data carrier by non-contact manner.

2. The individual information management system according to claim 1, wherein said individual is a person and the data stored in said data carrier includes medical information of said person.

3. The individual information management system according to claim 1, wherein said individual is an animal for experiment and the data stored in said data carrier includes at least one of either the hereditary information or the experimental history of said animal for experiment.

4. An individual information management system to manage data of a plurality of individuals comprising:
a plurality of data carriers which are assigned to groups which are obtained by dividing said individuals, and which store intrinsic data of individuals belonging to said groups, and
an external device to read out said intrinsic data from said data carriers by non-contact manner.

5. An individual information management system to manage data of a plurality of individuals comprising:
a first data carrier which is attached to said individual, and which stores intrinsic data relating to said individual,
a plurality of second data carriers which are assigned to groups which are obtained by dividing said individuals, and which store intrinsic data of individuals belonging to said groups, and
an external device to read out said intrinsic data from said first data carrier by non-contact manner and read out intrinsic data from said second data carriers by non-contact manner.

6. The individual information management system according to claim 5, wherein said first and second data carriers can be written in new data from said external device by non-contact manner.

7. The individual information management system according to claim 5, wherein said individual is an animal for experiment, said first data carrier is buried into the body of said animal for experiment, and said groups correspond to cages for accommodating said animal for experiment.

8. The individual information management system according to claim 5, further comprising a first data read-out/write-in device to read out said data from said first data carrier and to write new data to said first data carrier, said data being stored in said first data carrier by radio communication.

9. The individual information management system according to claim 8, further comprising a second data read-out/write-in device to read out said data from said second data carrier and to write new data to said second data carrier, said data being stored in said second data carrier by radio communication.

10. The individual information management system according to claim 5, wherein at least one of said first data carrier and said second date carrier has information processing function to process information.

11. The individual information management system according to claim 5, wherein at least one of said first data carrier and said second data carrier has physical data input/output function other than said data readout/write-in function.

12. The individual information management system according to claim 11, wherein said first data carrier further includes measurement device to measure physical or chemical status of said individual via said physical data input/output function.

13. The individual information management system according to claim 12, wherein at least one of said first data carrier and said second data carrier has information processing function which processes data measured from physical or chemical status of said individual according to a data processing program, said data processing program being able to be rewritten from outside by means of radio communication.

14. The individual information management system according to claim 11, wherein said first data carrier further includes means to effect physical or chemical action to said individual through said physical data input/output function.

15. The individual information management system according to claim 14, wherein said first data carrier further includes information processing function to process information, said first data carrier controlling said means to effect physical or chemical action using said information processing function according to an operation controlling program, and said operation controlling program being able to be updated from outside by means of radio communication.

16. The individual information management system according to claim 5, wherein at least one of said first data carrier and said second data carrier is supplied power therefor from outside by means of radio communication.

17. An individual information managing method comprising:
attaching a data carrier to an individual, said data carrier having storing function to store data relating to said individual, data input/output function to write new data in said data carrier from outside in non-contact manner and to read out stored data from said data carrier from outside in non-contact manner, said data carrier further having phisycal input/output function,
storing information relating to said individual,
whereby correspondence between said individual and said data relating to said individual being enhanced by carrying said data carrier.

18. The individual information managing method according to claim 17, wherein said individual is a person and said information relating to said individual, which is stored in said data carrier, includes medical information of said person.

19. An individual information managing method for managing a plurality of individuals comprising:
attaching a plurality of first data carriers to individuals, said data carriers having storing function to store intrinsic data relating to said individuals, said first data carriers being read out said intrinsic data relating to said individuals from outside in non-contact manner;
providing a plurality of second data carriers assigned to groups which are obtained by dividing said plurality of individuals, and which store intrinsic data of said individuals belonging to said groups and permit reading out said intrinsic data of said individuals from outside by radio communication;
retrieving said intrinsic individual data stored in said second data carriers to specify a group to where an objective individual belongs; and
specifying the objective individual by reading out intrinsic individual data from said first data carriers attached to individuals belonging to specified group.
